(19) United States
(12) Patent Application Publication
(10) Pub. No.: US 2014/0279077 A1
(43) Pub. Date: Sep. 18, 2014

(54) SYSTEMS, METHODS AND APPARATUS FOR ONLINE MANAGEMENT OF A SALES AND REFERRAL CAMPAIGN

(71) Applicants: Deven Scott NEMER, Thousand Oaks, CA (US); Gregory FRIEDMAN, Los Angeles, CA (US)

(72) Inventors: Deven Scott NEMER, Thousand Oaks, CA (US); Gregory FRIEDMAN, Los Angeles, CA (US)

(73) Assignee: NEVADA FUNDING GROUP INC.

(21) Appl. No.: 14/211,392

(22) Filed: Mar. 14, 2014

Related U.S. Application Data
(60) Provisional application No. 61/792,750, filed on Mar. 15, 2013.

(51) Int. Cl. G06Q 30/02

(52) U.S. Cl. CPC G06Q 30/0277
USPC 705/14.73

(57) ABSTRACT

Information relating to a campaign is received from a user device, via a network, wherein the information comprises first data identifying a plurality of leads and second data defining at least one action to be performed with respect to each respective lead. Performance of the at least one action with respect to the plurality of leads is monitored. A measure of performance of the at least one action with respect to the at least one lead is determined. The user device is caused to display the measure of performance,

### This application claims priority from U.S. Provisional Application No. 61/792,750, filed Mar. 15, 2013, which is hereby incorporated by reference herein in its entirety.

### TECHNICAL FIELD

This specification relates generally to systems and methods for managing sales and referral campaigns, and more particularly to systems and methods for online management of a sales and referral campaign.

### BACKGROUND

Sales and referrals campaigns are common tools used to promote business in a variety of industries. When a salesperson engages in such a campaign, he or she often relies on his or her own organizational skills to plan and execute the campaign. For example, the salesperson may draw up lists of personal contacts, collect notes about various contacts, and begin to contact leads based on his or her own personal style and on his or her own initiative. There is a need for systems and methods that automate elements of sales and referrals campaigns to render such campaigns more efficient and successful.

### SUMMARY

In accordance with an embodiment, information relating to a campaign is received from a user device, via a network, wherein the information comprises first data identifying a plurality of leads and second data defining at least one action to be performed with respect to each respective lead. Performance of the at least one action with respect to the plurality of leads is monitored. A measure of performance of the at least one action with respect to the at least one lead is determined. The user device is caused to display the measure of performance.

In one embodiment, the at least one action comprises one of calling a lead and sending a message to a lead.

In another embodiment, the measure of performance comprises a measure of a number of actions that have been completed relative to the at least one action defined in the second data. The measure of performance may comprise a measure of a number of actions completed with respect to a selected one of the plurality of leads.

In another embodiment, a website accessible via the network is maintained, wherein the website is accessible to registered users. The at least one action comprises obtaining a registration with the website by a lead.

In another embodiment, the network comprises the Internet.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a network manager in accordance with an embodiment;

FIG. 3 shows components of a referral manager in accordance with an embodiment;

FIG. 4 shows a user login page in accordance with an embodiment;

FIG. 5 shows a menu page in accordance with an embodiment;

FIG. 6A shows a manage campaign page in accordance with an embodiment;

FIG. 6B is a flowchart of a method of creating and monitoring the progress of a campaign in accordance with an embodiment;

FIG. 7 shows a create campaign page in accordance with an embodiment;

FIG. 8 shows a new lead page in accordance with an embodiment;

FIG. 9 shows a create goals page in accordance with an embodiment;

FIG. 10 shows a create campaign page in accordance with an embodiment;

FIG. 11A shows a select campaign page in accordance with an embodiment;

FIG. 11B shows a campaign progress report page in accordance with an embodiment;

FIG. 11C shows a leads list page in accordance with an embodiment;

FIG. 11D shows a lead information page in accordance with an embodiment;

FIG. 11E Shows a progress report page in accordance who an embodiment;

FIG. 11F shows a resources page in accordance with an embodiment;

FIG. 11G shows a contacts/leads box and a contact notes box in accordance with an embodiment;

FIG. 11H shows a create new step page in accordance with an embodiment;

FIG. 11I shows a template preview page in accordance with an embodiment;

FIG. 11J shows a system for allowing a team to collaborate in accordance with an embodiment;

FIG. 12 is a high-level block diagram of an exemplary computer that may be used to implement certain embodiments.

### DETAILED DESCRIPTION

FIG. 1 shows a communication system in accordance with an embodiment. Communication system 100 comprises a network 105, a network manager 135, and a referral manager 165. Communication system 100 also comprises a plurality of user devices 160-A, 160-B, 160-C, etc.

For convenience, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. In one embodiment, user device 160 may include an Internet browser that enables a user to access content via the Internet. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Network manager 135 controls access to content and services. FIG. 2 shows components of network manager 135 in accordance with an embodiment. Network manager 135 includes a controller 210, a user registration & login module 220, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, in the illustrative embodiment of FIG. 2, a user registration database 265 containing usernames, passwords, and other information relating to various users is stored in storage 230. Network manager 135 may include other components not shown in FIG. 2.

In one embodiment, network manager 135 manages One or more websites that are accessible to registered users. Registered users may utilize the one or more websites to interact in a variety of ways, to play games, to purchase products and services, to search for desired information, etc. Consequently, network manager 135 manages a network of registered users.

Referral manager 165 provides an online service that enables a user to create and manage a sales and/or referral campaign. For example, referral manager 165 allows a user to create and maintain a list of leads and/or contacts, specify goals for a campaign, and track the user's progress toward the specified goals. FIG. 3 shows components of referral manager 165 in accordance with an embodiment. Referral manager 165 comprises a campaign module 310 and a storage 320. Campaign module 310 provides an online platform Which a user may utilize to define a sales or referral campaign, establish goals for the campaign, and monitor progress to the campaign goals. Storage 320 is used from time to time by other components to store data. For example, campaign module 310 may store information relating to one or more sales or referral leads in a leads database 333 stored in storage 320, as shown in FIG. 3. Similarly, campaign module 310 may store information relating to a campaign established by a user in a campaign database 337 stored in storage 320, as shown in FIG. 3.

In an illustrative embodiment, a (registered) user employing user device 160-A accesses a website maintained by network manager 135. The website is associated with to network of users who are registered users of the network. Each registered user receives certain privileges including access to various services provided by network manager 135.

In one embodiment, the user may utilize a browser application (not shown) residing and operating on user device 160-A to access the website managed by network manager 135. Upon accessing the website, user registration & login module 220 (of network manager 135) provides a user login nape such as that shown in FIG. 4. User login page 400 includes a username field 410 and a password field 420.

After the user enters a valid username and password, and is authenticated, controller 210 (of network manager 135) causes the browser on user device 160-A to display a menu page such as that shown in FIG. 5 that indicates one or more products and/or services available via the website. Menu page 500 presents a plurality of selections including a search button 510, a games button 520, a manage campaign button 530, a store button 540, a messages button 550, and a music button 560. Other selections may be included.

In the illustrative embodiment, the user of user device 160-A wishes to create a referrals campaign. Specifically, the user wishes to establish and undertake a campaign to refer a plurality of individuals to the online network maintained by network manager 135. Specifically, the user wishes to convince each of the individuals to register with network manager 135 as a user of the network. Finally, the user wishes to convince each individual to make a purchase within the network for to become a paying member of the network).

Accordingly, the user selects manage campaign button 530. Network manager 135 receives the user's selection and transmits the request to referral manager 165, In response to the selection, referral manager 155 causes user device 160-A to display a Manage Campaign page such as that shown in FIG. 6A. Manage campaign page 600 comprises a Create New Campaign button 610 and a Campaign Progress Report button 635. In the illustrative embodiment, the user, wishing to create a new campaign, selects Create New Campaign button 610.

FIG. 6B is a flowchart of a method of creating and monitoring the progress of a campaign in accordance with an embodiment. At step 663, information relating to a campaign is received from a user device, via a network, wherein the information comprises first data identifying a plurality of leads and second data defining at least one action to be performed with respect to each respective lead. In the illustrative embodiment, in response to the user's selection, referral manager 165 causes user device 160-A to display a Create Campaign page such as that shown in FIG. 7. Create Campaign page 700 allows a user to establish a sales and/or referral campaign by defining one or more parameters. Thus, for example, Create Campaign page 700 comprises a “Campaign Name” field 707, and a “Number of Leads” field 711 indicating the number of leads associated with the campaign. An “ADD NEW LEAD” option 722 is provided under “Number of Leads” field 711. Create Campaign page 700 also includes a “Create Goals” section 713 that enables a user to define one or more goals to be achieved during the campaign. Create Campaign page 700 also comprises an end date field 715 enabling the user to define an end date when the campaign is scheduled to end. A user may use the options provided on Create Campaign page 700 to define a campaign.

In the illustrative embodiment, the user enters a name (“Campaign Alpha”) in campaign name field 707. The user now wishes to enter information concerning one or more leads to be contacted during the campaign, and accordingly selects ADD NEW LEAD button 722. In response, referral manager 165 causes user device 160-A to display a “New Lead” page such as that shown in FIG. 8. New Lead page 800 comprises a plurality of fields that enable the user to enter various types of information concerning a particular lead. As used herein, a lead is a person or entity that may be pursued with the goal of obtaining a registration, a sale, or another action from that person or entity. Thus, for example, New Lead page 800 comprises a name field 801, an address field 802, a company field 803, a telephone number field 804, an email field 805, and a notes field 806. In other embodiments, other fields corresponding to other types of information may be included. When the user has entered information concerning the lead and wishes to create and store a new lead, the user may select an ADD NEW LEAD button 818. Information concerning new leads is stored in leads database 333 within storage 320, as shown in FIG. 3.

In the illustrative embodiment, the user utilizes page 800 to add a plurality of leads, generating a list of leads associated with the campaign.

The user, now wishing to create goals for the campaign, returns to Create Campaign page 700 and selects EDIT GOALS button 724. In response to the user's selection, referral manager 165 causes user device 160-A to display a “Create Goals” page such as that shown in FIG. 9. Create Goals page 900 displays a plurality of options representing action steps that may be taken to pursue a particular lead. In the illustrative embodiment of FIG. 9, Create Goals page 900 includes a “Cali Lead” option 921, an “Email Lead” option 923, a “Lead Registers” option 925, and a “Sale to Lead” option 927. FIG. 9 is illustrative only; in other embodiments, other options relating to other types of action steps may be provided.

In the illustrative embodiment, the user selects all of the options 921, 923, 925, 927, and then selects a CONTINUE button 938 to return to the “Create Campaign” page 700. As a result, referral manager 165 stores the user's selection in campaign database 337, and causes user device 160-A to update and display “Create Campaign” page 700. Referring to FIG. 10, “Create Campaign” page 700 now indicates, in field 711, that the user has created, and saved information for forty-three (43) leads. “Create Campaign” page 700 now also includes four action steps 1061, 1062, 1063, 1064 listed in the “Create Goals” section 713. The user enters an end date (“July 31”) in end date field 715.

Wishing to save the information for the campaign, the user selects a SAVE CAMPAIGN button 792. Referral manager 165 accordingly saves the information for the campaign in campaign database 337.

At step 665, performance of the at least one action with respect to the plurality of leads is monitored. Suppose now that the user starts the campaign and accordingly begins to follow the action steps set forth in “Create Campaign” page 700, with respect to each lead associated with the campaign. Referring to FIG. 10, the user therefore begins to call each lead, send an email to each lead, etc. For example, the user may call, and send an email message to, a first lead associated with user device 160-B. The user attempts to convince each lead to register with the network. Finally, the user attempts to convince the lead to make a purchase of one or more services within the network (and/or become a paying member). Referral manager 165 monitors the user's activities during the campaign and at various stages determines whether the user has met predetermined benchmarks, or a specified schedule of action steps.

At step 667, a measure of performance of the at least one action with respect to the at least one lead is determined. Referral manager 165 may use one or more formulae to determine a measure indicating to what degree the user is meeting the benchmarks or specified schedule. For example, in the illustrative embodiment, when the user has called all of the leads on the list of leads, referral manager 165 may determine that the user has completed 25% of the scheduled action steps; when the user has sent an email to all of the leads on the list of leads, referral manager 165 may determine that the user has completed 50% of the scheduled action steps; etc.

At step 669, the user device is caused to display the measure of performance. In the illustrative embodiment, at a later date (after the campaign has begun), the user may view a progress report that provides information concerning the status of the campaign. For example, a user may again access “Manage Campaign” page 600 (shown in FIG. 6A) and select CAMPAIGN PROGRESS REPORT button 635.

In response to the user's selection, referral manager 165 causes user device 160-A to display a select campaign page such as that shown in FIG. 11A. Page 1110 prompts the user to enter the name of a desired campaign in a campaign name field 1113. In the illustrative embodiment, the user enters “Campaign Alpha” and selects a “View Progress Report” button 1115.

In response to the user's selection, referral manager 165 causes user device 160-A to display a “Campaign Progress Report” page such as that shown in FIG. 11B. In various embodiments, a campaign progress report page may display various types of information relating to a campaign that may be useful to the user. The information may be displayed in any suitable form. The information may include raw data and/or analyses of the raw data.

In the illustrative embodiment, Campaign Progress Report page 1120 comprises a Leads chart 1121 and a progress chart 1125. Leads chart 1121 indicates a first percentage of leads that are deemed “hot leads,” a second percentage of leads deemed “warm leads,” and a third percentage of leads deemed “cold leads.” These categories may be determined in any manner useful to a user. For example, a cold lead may be a lead whom the user has called multiple times and sent multiple email messages to, yet has not responded. For example, a hot lead may be a lead who has registered with the network.

Progress report chart 1125 may indicate, for example, a measure of performance such as a percentage of action steps that have been completed at various selected dates during the campaign. In other embodiments, a progress report chart may show other types of information.

In the illustrative embodiment, the user wishes to view a list of leads associated with the campaign, and accordingly selects a “View All Leads” button 1122.

In response to the user's selection, referral manager 165 causes user device 160-A to display a leads list page containing a list of leads, such as page 1130 shown in FIG. 11C. Page 1130 displays a list of leads including leads 1131, 1132, etc. A “View” option is displayed beside each respective lead, inviting the user to view more information about the respective lead. Thus, a “View” option 1136 is displayed next to lead 1131; a “View” option 1137 is displayed next to lead 1132; etc. In the illustrative embodiment, the user, wishing to view additional information concerning the lead named “Smith, R.,” selects “View” button 1137.

In response to the user's selection, referral manager 165 causes User device 160-A to display a lead information page such as that shown in FIG. 11D. Lead information page contains fields 1141, 1142, 1143, 1144, and 1145, which display various items of information relating to the lead named “Smith, R.” Lead information page 1140 also comprises a progress section 1152 that displays measures of progress with respect to the particular lead. In the illustrative embodiment, progress section 1152 includes indicators corresponding to the respective action steps defined in the campaign. Thus, progress section 1152 includes a “Call Lead” indicator 1146, an “Email Lead” indicator 1147, a “Lead Registers” indicator 1148, and a “Sale to Lead” indicator 1149. In the illustrative embodiment, indicator 1146 indicates that the user has called the lead; the other indicators indicate that no other action steps have been completed.

FIG. 11E shows a progress report page in accordance with another embodiment. Progress report page 2010 comprises a leads region 2020, indicating a number of hot leas, warm leads, and cold leads, how many action steps need to be taken during the current week, now many success items have taken place during the current week, etc. A statistics region 2030 displays graphically information such as numbers of new leads. An action region indicates a list of action to be taken and notes related to each respective action. An action steps region 2050 indicates a number of action steps to be taken, how many phone calls, how many personal messages, how many in-person visits, etc.

In another embodiment, a social referral management and team building system is provided. Advantageously, data has more value when you're working with a group of people and that group can combine their leads and resources. Such a system comprises a global pool of resources including, but not limited to (a) scripts to be used during calls; (b) templates for email messages; (c) videos and audio recordings; (d) recorded webinars; and (e) presentations to be used in person (one on one and to a group).

The social referral management and team system may be implemented across a wide variety of industries as well as for the purpose of bringing in new members to a social network,

In another embodiment, recruiting tools and resources tied to a social network are provided, where the lead can easily volunteer their own information to the salesperson and what's provided through the network can be combined with data elsewhere on the web through various sites as well as manually entered in by the sales person. This data manually entered in could he from a pre-existing relationship and the knowledge that they have about the individual, taken over the phone or in person, or gathered by any other means.

FIG. 11F shows a resources page that may be provided in accordance with an embodiment. Page 2100 includes selections related to various resources, including a “Create Yourself” option 2210, a “Cold Call Script” option 2120, an “Email Templates” option 2130, a “Video &, Audio Recordings” option 2140, a “Recorded Webinars” option 2150, and a “One-on one Presentations” option 2160.

In another embodiment illustrated in FIG. 110, contact/lead information relating to a particular lead may be displayed in combination with notes relating to the lead. FIG. 11G shows a contact/lead info box 2200 and a contact notes box 2210 that may be displayed on a user device. For example, contact/lead box 2200 may include information such as the lead's name, address, telephone number, etc. Contact notes box 2210 may comprise notes indicating an action to be taken, personal notes, etc.

In another embodiment, systems and methods are provided to generate data across companies, industries, geography, and demographics to generate reports of what works the best in specific use case scenarios for the purpose of sharing this data with the members and allow them to tailor their messages with proven formulas.

In another embodiment, data generated in the manner described above is applied to give suggestions such as “if you called 20 more people with {this script}, you have an 80% probability of referring in 2 new members, which will bump you up to this level and boost your monthly income.

In another embodiment, built-in. training tools are provided that identify people that are struggling and offer lessons/courses that would improve their abilities, their closing ratios, and the total number of people they are able to get in contact with. Again this is for recruiting people into a social network as well as the ability to apply it to a wide variety of industries.

In another embodiment, systems and methods are provided to track the simple metrics of attempts and success so that it can be applied in the various ways mentioned above. In one embodiment, a simple mathematical formula is used.

In another embodiment, an online store is provided to sell resources and training material as well as a recommendation engine that takes into account what you're doing and how well its working for you, to offer resources that have proven to be better for other similar people.

In another embodiment illustrated in FIG. 11H, a system and method are provided to allow a user to create a new action step and to define a team associated with the action step. FIG. 11H shows a “Create New Step” page 2300. Page 2300 comprises a step name field 2304 and a step description field 2305 which enable a user to define the new action step. Page 2300 also includes a start date field 2311 and an end date field 2312 enabling a user to specify a time period for the action step. Page 2300 also comprises a Team Selection section 2325 which allows the user to select a team for the action step.

In another embodiment illustrated in FIG. 11I, a system and method for providing a template preview of an available template are provided. Template, preview page 2400 includes a template information section showing a number of downloads of the template, a rating of the template, a price for the template, and a “BUY” option allowing the user to purchase the template. Page 2400 also includes a. template preview section 2420 showing all or a portion of the template, and a template description section comprising a description of the template.

In another embodiment illustrated in FIG. 11J, a system and method for enabling a team to collaborate are provided. FIG. 11J shows a team 2550 comprising team members 2552, and a web page 2510 which may be displayed, for example, on user device 160, Page 2510 includes a first region 2561 that comprises a live-interactive area, and a second region 2562 which displays information relating to the team members and/or other persons.

In various embodiments, the method steps described herein, including the method steps described in FIG. 6B, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may he used within a network based cloud computing system. In such a network-based cloud computing system, a server or another processor that is connected to a network communicates with one or more client computers via network. A client may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to per arm a calculation, to display specified data on a screen, etc.

Systems, apparatus, and methods described herein may be implemented using a computer program product tangibly embodied in an information carrier, e.g., in a non-transitory machine-readable storage device, for execution by a programmable processor, and the method steps described herein, including one or more of the steps of FIG. 6B, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 12. Computer 1200 includes a processor 1201 operatively coupled to a data storage device 1202 and a memory 1203. Processor 1201 controls the overall operation of computer 1200 by executing computer program instructions that define such operations. The computer program instructions may be stored in data storage device 1202, or other computer readable medium, and loaded into memory 1203 when execution of the computer program instructions is desired. Thus, the method steps of FIG. 6B can be defined by the computer program instructions stored in memory 1203 and/or data storage device 1202 and controlled by the processor 1201 executing the computer program instructions. For example, the computer program instructions can be implemented as computer executable code programmed by one skilled in the art to perform an algorithm defined by the method steps of FIG. 6B. Accordingly, by executing the computer program instructions, the processor 1201 executes an algorithm defined by the method steps of FIG. 6B. Computer 1200 also includes one or more network interfaces 1204 for communicating with other devices via a network. Computer 1200 also includes one or more input/output devices 1205 that enable user interaction with computer 1200 (e.g., display, keyboard, mouse, speakers, buttons, etc.).

Processor 1201 may include both general and special purpose microprocessors, and may be the sole processor or one of multiple processors of computer 1200. Processor 1201 may include one or more central processing units (CPUs), for example. Processor 1201, data storage device 1202, and/or memory 1203 may include, be supplemented by, or incorporated in, one or more application-specific integrated circuits (ASICs) and/or one or more field programmable gate arrays (FPGAs).

Data storage device 1202 and memory 1203 each include a tangible non-transitory computer readable storage medium. Data storage device 1202, and memory 1203, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1205 may include peripherals, such as a printer, scanner, display screen, etc. For example, input/output devices 1205 may include a display device such as a cathode ray tube (CRT) or liquid crystal display (LCD) monitor for displaying information to the user, a keyboard, and a pointing device such as a mouse or a trackball by which the user can provide input to computer 1200.

Any or all of the systems and apparatus discussed herein, including network manager 135, referral manager 165, and user device 160, and components thereof, including controller 210, user registration & login module 220, and storage 230, may be implemented using a computer such as computer 1200.

One skilled in the art will recognize that an implementation of an actual computer or computer system may have other structures and may contain other components as well, and that FIG. 12 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving, by a processor, from a user device, via a network, information relating to a campaign, the information comprising first data identifying a plurality of leads and second data defining at least one action to be performed with respect to each respective lead;
monitoring, by the processor, performance of the at least one action with respect to the plurality of leads;
determining, by the processor, a measure of performance of the at least one action with respect to the at least one lead; and
causing the user device to display the measure of performance.

2. The method of claim 1, wherein the at least one action comprises one of calling a lead and sending a message to a lead.

3. The method of claim 1, wherein the measure of performance comprises a measure of a number of actions that have been completed relative to the at least one action defined in the second data.

4. The method of claim 3, wherein the measure of performance comprises a measure of a number of actions completed with respect to a selected one of the plurality of leads.

5. The method of claim 1, wherein:
the processor maintains a website accessible via the network, wherein the website is accessible to registered users; and
the at least one action comprises obtaining a registration with the website by a lead.

6. The method of claim 1, wherein the network comprises the Internet.

7. A system comprising:
a storage adapted to store information relating to a campaign; and
a processor adapted to:
receive from a user device, via a network, information relating to a campaign, the information comprising first data identifying a plurality of leads and second data defining at least one action to be performed with respect to each respective lead;
monitor performance of the at least one action with respect to the plurality of leads;
determine a measure of performance of the at least one action with respect to the at least one lead; and
cause the user device to display the measure of performance.

8. The system of claim. 7, wherein the at least one action comprises one of calling a lead and sending a message to a lead.

9. The system of claim 7, wherein the measure of performance comprises a measure of a number of actions that have been completed relative to the at least one action defined in the second data.

10. The system of claim 9, wherein the measure of performance comprises a measure of a number of actions completed with respect to a selected one of the plurality of leads.

11. The system of claim 7, wherein:
the processor maintains a website accessible via the network, wherein the website is accessible to registered users; and
the at least one action comprises obtaining a registration with the website by a lead.

12. The system of claim 7, wherein the network comprises the Internet.
